(19) United States
(12) Patent Application Publication
(10) Pub. No.: US 2026/0121339 A1
(43) Pub. Date: Apr. 30, 2026

(54) CONNECTOR

(71) Applicant: SUMITOMO WIRING SYSTEMS, LTD., Mie (JP)

(72) Inventor: Yosuke MORINAGA, Mie (JP)

(21) Appl. No.: 19/365,613

(22) Filed: Oct. 22, 2025

(30) Foreign Application Priority Data
Oct. 24, 2024 (JP) 2024-187253

(51) Int. Cl. H01R 13/52; H01R 13/512; H01R 13/6581

(52) U.S. Cl. CPC H01R 13/5202; H01R 13/512; H01R 13/5213; H01R 13/5216; H01R 13/6581

(57) ABSTRACT

A connector includes a shield shell that is made of metal and covers terminals, and a cover member that is attached to the shield shell so as to close an opening in the shield shell. The cover member includes a cover main body, which is made of metal and includes a first base portion that covers the opening, a frame-shaped insertion portion that protrudes from the first base portion in a forward direction and is inserted into the shield shell, and a first engagement portion. The cover member is attached to an outer circumference of the insertion portion and includes an annular sealing member that forms a seal between the insertion portion and the shield shell. The cover member is attached to the cover main body and includes retainer that is made of synthetic resin and prevents the sealing member from coming off the insertion portion.

### CROSS-REFERENCE TO RELATED APPLICATIONS

This application is based on and claims priority from Japanese Patent Application No. 2024-187253, filed on Oct. 24, 2024, with the Japan Patent Office, the disclosure of which is incorporated herein in its entirety by reference.

### TECHNICAL FIELD

The present disclosure relates to a connector.

### BACKGROUND

A known conventional example of a connector mounted in a vehicle is a waterproof connector including a shield shell that is made of metal and covers a terminal, a cover that covers an opening in the shield shell, and a sealing member that forms a seal between the shield shell and the cover (see, for example, Japanese Patent Laid-open Publication No. 2024-100138). The cover includes a frame-like insertion portion that is inserted into an internal space of the shield shell. The sealing member is attached to an outer periphery of this insertion portion. A protrusion that prevents the sealing member from coming off the insertion portion is also formed at the front end of the insertion portion.

### SUMMARY

However, there is demand for the connector described above to improve waterproof properties.

It is an object of the present disclosure to provide a connector with improved waterproof properties.

A connector according to an aspect of the present disclosure is a connector including: a terminal that is electrically conductive; a shield shell that is made of metal and covers the terminal; and a cover member that is attached to the shield shell along a first direction so as to cover an opening provided in the shield shell, wherein the cover member includes: a cover main body that is made of metal and includes a first base portion that covers the opening, an insertion portion that is frame-shaped, protrudes from the first base portion in the first direction and is inserted into the shield shell, and a first engagement portion; an annular sealing member that is attached to an outer periphery of the insertion portion and forms a seal between the insertion portion and the shield shell; and a retainer that is made of synthetic resin, is attached to the cover main body, and prevents the sealing member from coming off the insertion portion, and wherein the retainer includes a second engagement portion formed to be capable of engaging the first engagement portion.

According to the connector according to an aspect of the present disclosure, waterproof properties can be improved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a connector according to an embodiment of the present disclosure.

FIG. 2 is an exploded perspective view showing the connector according to the embodiment.

FIG. 3 is an exploded perspective view showing a cover member according to the embodiment.

FIG. 4 is a cross-sectional view (a cross-sectional view along a line 4-4 in FIG. 8) showing the connector according to the embodiment.

FIG. 5 is a perspective view showing a retainer according to the embodiment.

FIG. 6 is a cross-sectional view (a cross-sectional view along a line 6-6 in FIG. 8) showing the cover member according to the embodiment.

FIG. 7 is a cross-sectional perspective view showing the cover member according to the embodiment.

FIG. 8 is a cross-sectional view (a cross-sectional view along a line 8-8 in FIG. 4) showing the connector according to the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

Several embodiments of the present disclosure will first be listed and described below.

(1) A connector according to an aspect of the present disclosure is a connector including: a terminal that is electrically conductive; a shield shell that is made of metal and covers the terminal; and a cover member that is attached to the shield shell along a first direction so as to cover an opening provided in the shield shell, wherein the cover member includes: a cover main body that is made of metal and includes a first base portion that covers the opening, an insertion portion that is frame-shaped, protrudes from the first base portion in the first direction and is inserted into the shield shell, and a first engagement portion; an annular sealing member that is attached to an outer periphery of the insertion portion and forms a seal between the insertion portion and the shield shell; and a retainer that is made of synthetic resin, is attached to the cover main body, and prevents the sealing member from coming off the insertion portion, and wherein the retainer includes a second engagement portion formed to be capable of engaging the first engagement portion.

With the above configuration, the cover member attached to the shield shell includes a cover main body that is made of metal and includes an insertion portion that is inserted into the shield shell, a sealing member attached to the outer periphery of the insertion portion, and a retainer that is made of synthetic resin and prevents the sealing member from coming off. This means that the retainer, which is a separate component from the cover main body, can prevent the sealing member from coming off the insertion portion. Accordingly, it is unnecessary to provide a structure, such as a protrusion, for preventing the sealing member from coming off at the front end of the insertion portion of the cover main body.

Here, if a protrusion that is perpendicular to the insertion direction were provided at the front end of the insertion portion, it is necessary to manufacture the cover main body using a complex slide mold. In this case, since a parting line of the slide mold is formed so as to extend along the axial direction of the insertion portion, burrs may be formed along the parting line on the outer surface of the insertion portion, that is, on a sealed surface. Since such burrs can reduce the sealing performance of the sealing member, machining, such as cutting, to remove the burrs is required. Even if burrs are removed by cutting, minute differences in height may be produced between cut surfaces and the rest of the outer surface of the insertion portion. If such minute height differences are produced in a sealed surface, the sealing performance of the sealing member may be reduced.

In view of this, with the configuration described above, since it is unnecessary to provide a protrusion at the front end of the insertion portion, it is possible to manufacture the cover main body without using a slide mold. By doing so, no burrs are formed on the outer surface of the insertion portion (i.e., the sealed surface), so there is no need to perform cutting to remove burrs. Accordingly, it is possible to favorably suppress the formation of minute height differences, which are caused by cutting, on the sealed surface. As a result, it is possible to improve the sealing performance of the sealing member compared to when a protrusion is provided at the front end of the insertion portion, and in turn to improve the waterproof properties of the connector.

(2) In the connector according to (1) above, the second engagement portion may be an elastic piece capable of elastic deformation in a second direction that is perpendicular to the first direction, the cover main body may include a pair of protrusions provided so as to sandwich the first engagement portion in a third direction that is perpendicular to both the first direction and the second direction, the retainer may include a pair of holes provided so as to sandwich the second engagement portion in the third direction, each protrusion in the pair of protrusions may protrude in the first direction from a first direction-end surface of the insertion portion, the pair of protrusions may be fitted into the pair of holes, and inner surfaces of the pair of holes may be capable of contacting the protrusions in the second direction.

According to this configuration, the second engagement portion that is engaged with the first engagement portion is formed to be capable of elastic deformation in the second direction that is perpendicular to the first direction. Here, since the cover main body is made of metal and the retainer is made of synthetic resin, the cover main body and the retainer have different thermal expansion coefficients. Due to this difference in coefficients of thermal expansion, the retainer may thermally shrink more than the cover main body. When this happens, if the retainer thermally shrinks more in the second direction, there is the risk of the engagement between the first and second engagement portions becoming unintentionally released.

In view of this, in the above configuration, a pair of protrusions are provided on the cover main body so as to sandwich the first engagement portion, and a pair of holes, into which the pair of protrusions are fitted, are provided on the retainer. In addition, the inner surface of each hole is provided so as to be capable of coming into contact with the metal protrusions in the second direction. Contact between the holes and the protrusions suppresses thermal shrinkage of the retainer in the second direction near the first engagement portion and the and second engagement portion. This suppresses large thermal shrinkage of the second engagement portion in the second direction. By doing so, it is possible to favorably suppress unintentional disengagement of the first engagement portion and the second engagement portion due to thermal shrinkage of the retainer.

(3) In the connector according to (1) or (2) above, the retainer may include a second base portion and a fitting portion that protrudes in a first opposite direction, which is an opposite direction to the first direction, from the second base portion, and the fitting portion may have an outer surface that conforms to an inner surface of the insertion portion and is fitted into the insertion portion.

According to this configuration, the fitting portion, which has an outer surface that conforms to the inner surface of the insertion portion, is fitted into the insertion portion. This means that the retainer can be attached to the cover main body while fitting the fitting portion inside the insertion portion. Accordingly, the retainer can be attached to the cover main body while being aligned by fitting the fitting portion into the insertion portion. As a result, the task of attaching the retainer to the cover main body can be facilitated.

(4) In the connector according to (3) above, the retainer may include one or a plurality of crushing ribs provided on an outer surface of the fitting portion, each crushing rib may extend along the first direction, and each crushing rib may be press-fitted into the insertion portion.

With this configuration, when the fitting portion is fitted into the insertion portion, each crushing rib is crushed by the inner surface of the insertion portion, so that each crushing rib is squeezed against the inner surface of the insertion portion. By doing so, rattling between the insertion portion and the fitting portion can be suppressed, which in turn suppresses rattling between the cover main body and the retainer.

(5) In the connector according to (3) or (4) above, the first base portion may include a first protruding portion that protrudes outward beyond the insertion portion, the second base portion may include a second protruding portion that protrudes outward beyond the fitting portion and faces the first protruding portion in the first direction, and the sealing member may be provided between the first protruding portion and the second protruding portion in the first direction.

According to this configuration, the sealing member is provided between the first protruding portion of the first base portion of the cover main body and the second protruding portion of the second base portion of the retainer. By doing so, it is possible for the second protruding portion and the first protruding portion to restrict movement of the sealing member in the first direction and the first opposite direction. Accordingly, detachment of the sealing member from the insertion portion can be favorably suppressed.

(6) In the connector according to any one of (3) to (5) above, the cover main body may include a first reinforcing rib formed to protrude in the first direction from a first direction-end surface of the first base portion, the second base portion may include a cover portion that covers an opening in the first direction of the fitting portion, and the retainer may include a second reinforcing rib formed to protrude in the first opposite direction from a first opposite direction-end surface of the cover portion.

According to this configuration, by providing the first reinforcing rib, the rigidity of the cover main body can be increased. Also, by providing the second reinforcing rib, the rigidity of the retainer can be increased.

(7) In the connector according to (6) above, a gap may be provided between a first direction-end surface of the first reinforcing rib and a first opposite direction-end surface of the second reinforcing rib.

With this configuration, when the retainer is attached to the cover main body, the first reinforcing rib and the second reinforcing rib do not come into contact with each other. This means that the generation of noise due to contact between the first reinforcing rib and the second reinforcing rib can be suppressed.

(8) In the connector according to (6) or (7) above, the retainer may include a fitting recess to which the first reinforcing rib is fitted, the fitting recess may be formed to be recessed in the first direction from a first opposite direction-end surface of the fitting portion, and an inner surface of the fitting recess may be capable of coming into contact with the first reinforcing rib in a direction that intersects the first direction.

According to this configuration, the first reinforcing rib is fitted into the fitting recess provided in the first opposite direction-end surface of the fitting portion. When doing so, since the inner surface of the fitting recess is capable of coming into contact with the first reinforcing rib in a direction that intersects the first direction, movement of the retainer in the direction that intersects the first direction can be suppressed.

(9) In the connector according to any one of (3) to (8) above, the sealing member may include a positioning protrusion that protrudes in the first direction from a first direction-end surface of the sealing member, the retainer may include a positioning recess into which the positioning protrusion is fitted, the positioning recess may be formed by cutting out an outer peripheral surface of the second base portion, and the inner surface of the positioning recess may be capable of coming into contact with the positioning protrusion in a second direction that is perpendicular to the first direction.

According to this configuration, the positioning protrusion of the sealing member is fitted into the positioning recess provided in the retainer. When doing so, since the positioning protrusion is capable of coming into contact with the inner surface of the positioning recess in the second direction, movement of the sealing member in the second direction can be suppressed.

### Detailed Embodiments of the Present Disclosure

Specific examples of a connector according to the present disclosure will be described below with reference to the accompanying drawings. In the drawings, for ease of explanation, parts of the configuration may be exaggerated or simplified. The relative dimensions of parts may also differ between drawings. In this specification, the expressions “parallel” and “perpendicular” do not refer only to states that are strictly parallel or perpendicular, and also include approximately parallel or perpendicular states within a range where the operation and effects of the present embodiments are achieved. In the present specification, the expression “facing” refers to the respective front-surface positions of different surfaces or members, and includes not only a case where the front surfaces completely coincide but also cases where the front surfaces partially coincide. In the present specification, the expression “facing” also includes both a case where another member is interposed between two parts that are said to be facing and a case where nothing is interposed between the two parts said to be facing. In the drawings, a first axis X, a second axis Y that is perpendicular to the first axis X, and a third axis Z that is perpendicular to both the first axis X and the second axis Y are indicated. A forward direction X1, which is one direction along the first axis X, and a rearward direction X2, which is the other direction along the first axis X and is the opposite direction to the forward direction X1, are also indicated in the drawings. An upward direction Y1, which is one direction along the second axis Y, and a downward direction Y2, which is the other direction along the second axis Y and is the opposite direction to the upward direction Y1, are also indicated in the drawings. A first width direction Z1, which is one direction along the third axis Z, and a second width direction Z2, which is the other direction along the third axis Z and is the opposite direction to the first width direction Z1, are also indicated in the drawings. Note that the respective directions in the drawings do not necessarily represent the posture of the connector during actual use. In addition, the expressions “first”, “second”, “third”, and the like in this specification are used simply to distinguish between objects and do not indicate rankings of the objects. Note that the present invention is not limited to the embodiments described here, is indicated by the scope of the patent claims, and is intended to include all modifications within the meaning and scope of the claims.

### (Overall Configuration)

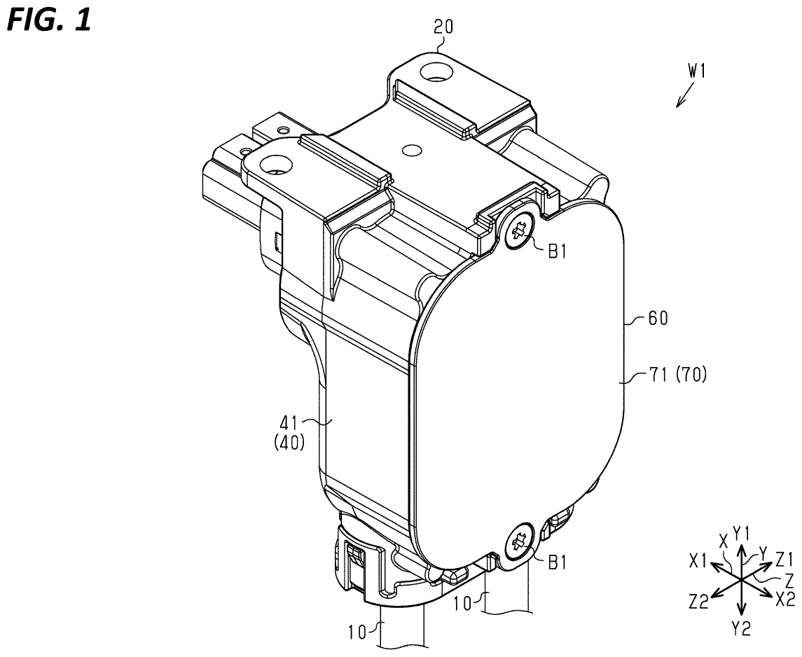

As depicted in FIG. 1, a wire harness W1 includes one or more electric wires 10 (in the present embodiment, two) and a connector 20 which is attached to ends of the electric wires 10. The wire harness W1 is installed in a vehicle, such as a hybrid vehicle or an electric vehicle. The wire harness W1 electrically connects electric devices used in a vehicle, such as a high-voltage battery, an inverter, and a motor for driving the wheels. As one example, the connector 20 is connected to a single electric device. The connector 20 is a waterproof connector. The electric wires 10 are shielded electric wires which include their own electromagnetic shielding structure, for example.

### (Overall Configuration of Connector 20)

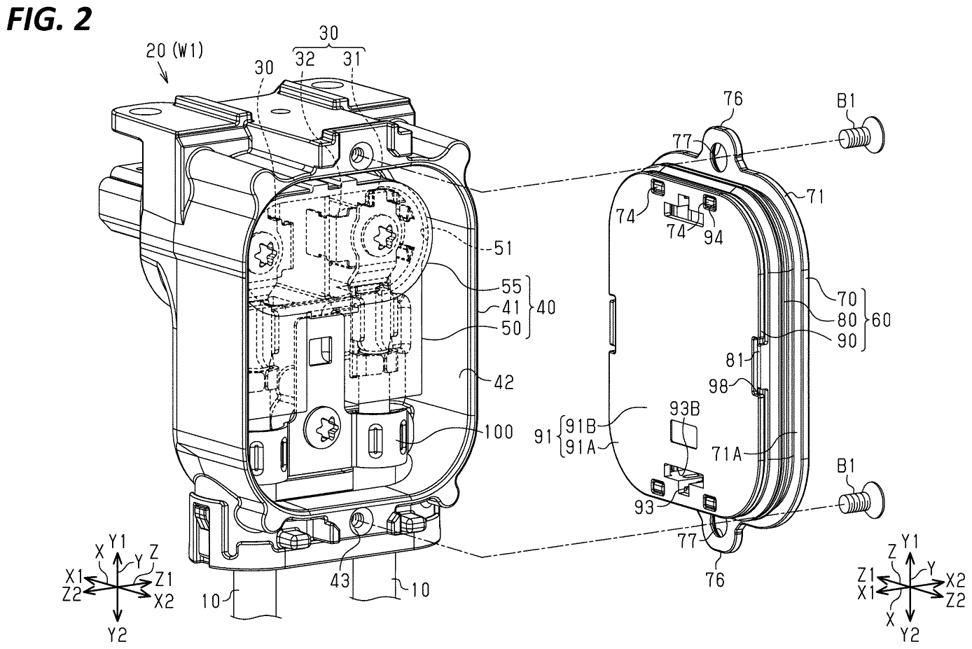

As depicted in FIG. 2, the connector 20 includes a plurality of terminals 30 that are respectively connected to the ends of the plurality of electric wires 10, and an annular connector housing 40 that houses the plurality of terminals 30. The connector housing 40 includes a shield shell 41 that is electrically conductive and covers the plurality of terminals 30, an inner housing 50 that is housed inside the shield shell 41, and a lid portion 55 that covers an opening in the inner housing 50. The connector 20 includes a cover member 60 that covers an opening in the connector housing 40, screws B1 that fix the cover member 60 to the shield shell 41, and a shield bracket 100 that is made of metal and fixed to the connector housing 40.

### (Configuration of Terminals 30)

The terminals 30 are housed inside the inner housing 50. Each terminal 30 includes an electric wire connecting portion 31, which is connected to an end of an electric wire 10 in the upward direction Y1, and a terminal connecting portion 32, which is connected to a counterpart terminal, not illustrated. As one example, the electric wire connecting portion 31 is screwed to the terminal connecting portion 32. Although not depicted in detail, each terminal connecting portion 32 protrudes from the electric wire connecting portion 31 in the forward direction X1. The terminals 30 may use a metal material such as copper or a copper alloy, for example.

### (Configuration of Inner Housing 50)

The inner housing 50 is made of synthetic resin, for example. The inner housing 50 is a separate component from the shield shell 41. The inner housing 50 is held inside the shield shell 41.

The inner housing 50 is formed so as to internally house two terminals 30. Connected parts of the electric wires 10 and the terminals 30 are housed inside the inner housing 50. The inner housing 50 includes an opening 51 that is open in the rearward direction X2. The opening 51 exposes the connected parts of the electric wire connecting portions 31 and the terminal connecting portions 32, which in the present embodiment is a screw-fastened part.

The lid portion 55 is attached to the inner housing 50 so as to cover the opening 51 in the inner housing 50. The lid portion 55 is provided so as to cover the entire opening 51.

### (Configuration of Shield Shell 41)

The shield shell 41 surrounds an outer periphery of the inner housing 50. The shield shell 41 is formed in the overall shape of a box. The shield shell 41 is made of metal. As examples, a metal material, such as aluminum-based material or an iron-based material, can be used as the material of the shield shell 41. The shield shell 41 in the present embodiment is made of die-cast aluminum.

The shield shell 41 is formed to internally house the inner housing 50, which holds the two terminals 30, the lid portion 55, and the shield bracket 100. The ends of the electric wires 10 in the upward direction Y1 are housed inside the shield shell 41. Note that the electric wires 10 extend out of the shield shell 41 along the downward direction Y2.

The shield shell 41 includes an opening 42 that is open in the rearward direction X2. The opening 42 is formed to communicate between the inside and the outside of the shield shell 41. The opening 42 exposes the inner housing 50, the lid portion 55, and the shield bracket 100. The overall planar shape of the opening 42 when viewed in the forward direction X1 is a rounded rectangle.

The shield shell 41 includes screw holes 43 into which the screws B1 are inserted. The shield shell 41 of the present embodiment includes two screw holes 43. Each screw hole 43 is provided on an end surface of the shield shell 41 that faces the rearward direction X2. The two screw holes 43 are provided on the second axis Y so as to sandwich the opening 42 between them.

### (Configuration of Shield Bracket 100)

The shield bracket 100 is fixed to the shield shell 41 by a screw. Although not depicted in detail, the shield bracket 100 is fixed to the shield shell 41 in a state where the shield bracket 100 is electrically connected to the electromagnetic shielding structures of the electric wires 10.

### (Configuration of Cover Member 60)

The cover member 60 is attached to the shield shell 41 so as to cover the opening 42 of the shield shell 41. The cover member 60 is provided so as to cover the entire opening 42. The cover member 60 is assembled onto the shield shell 41 in the forward direction X1.

The cover member 60 includes a cover main body 70, an annular sealing member 80 that is attached to the cover main body 70, and a retainer 90 that is attached to the cover main body 70 and prevents the sealing member 80 from coming off.

### (Configuration of Cover Main Body 70)

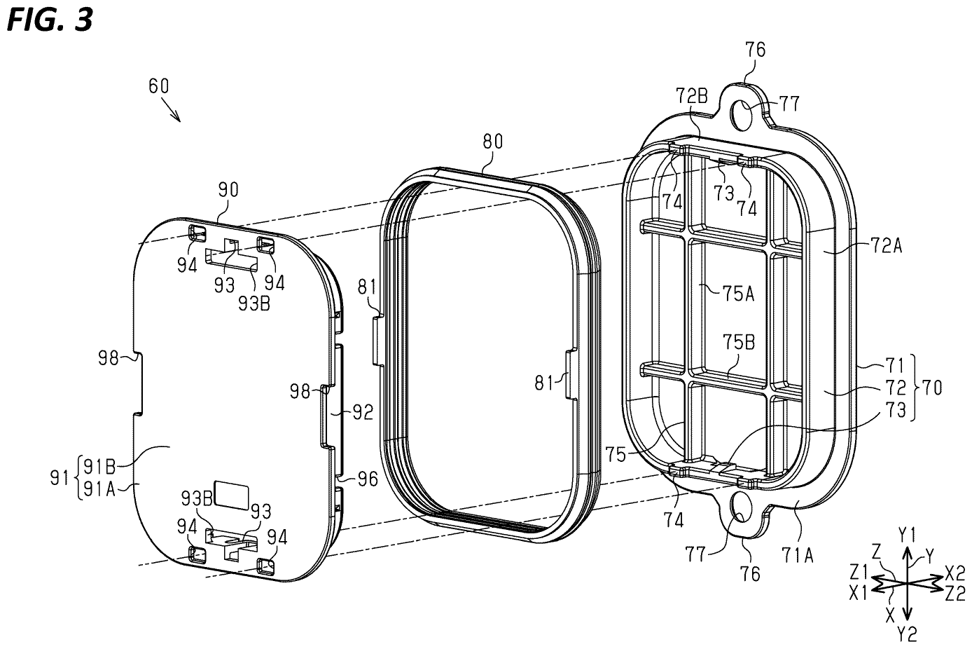

As depicted in FIG. 3, the cover main body 70 includes a first base portion 71, a frame-shaped insertion portion 72 formed on an end surface of the first base portion 71 in the end surface of the first base portion 71 in the forward direction X1, and first engagement portions 73. The cover main body 70 includes protrusions 74, first reinforcing ribs 75, and a fixing portion 76. The cover main body 70 is a single component in which the first base portion 71, the insertion portion 72, the first engagement portions 73, the protrusions 74, the first reinforcing ribs 75, and the fixing portion 76 are integrally formed. The cover main body 70 is made of metal. As examples, a metal material such as an aluminum-based material or an iron-based material can be used as the material of the cover main body 70. The cover main body 70 of the present embodiment is die-cast aluminum.

As depicted in FIG. 1, the first base portion 71 is formed in the shape of a flat plate. When viewed in the forward direction X1, the overall planar shape of the first base portion 71 is a rounded rectangle. The planar shape of the first base portion 71 as viewed in the forward direction X1 is a rounded rectangle with long sides that extend along the second axis Y and short sides that extend along the third axis Z. The first base portion 71 has a thickness along the first axis X.

As depicted in FIG. 3, the first base portion 71 is provided so as to cover the opening in the rearward direction X2 of the insertion portion 72. The first base portion 71 includes a first protruding portion 71A that protrudes outward from an outer surface of the insertion portion 72. The first protruding portion 71A is formed continuously around the entire circumference in the circumferential direction.

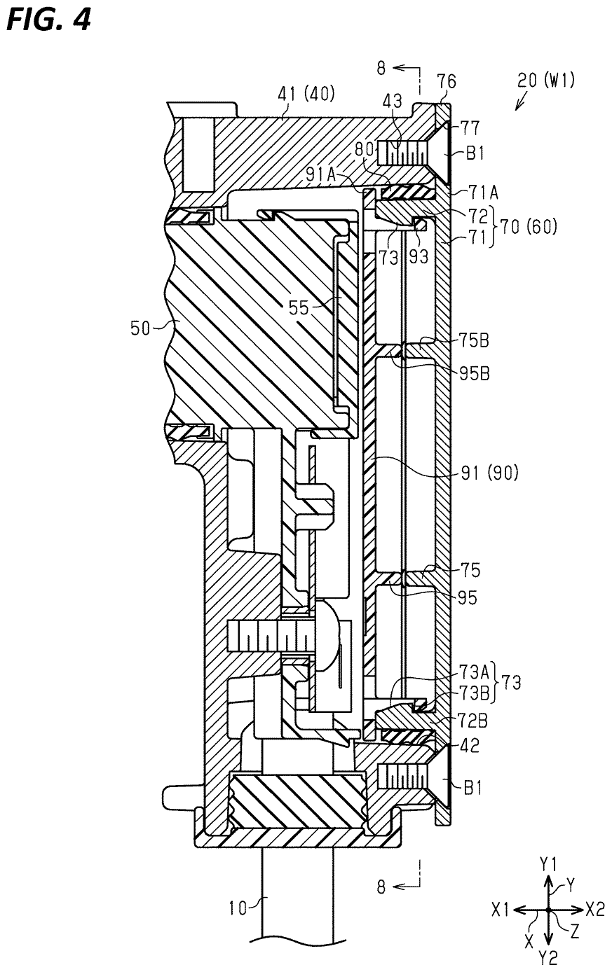

As depicted in FIG. 4, the first protruding portion 71A is formed so as to face the sealing member 80 on the first axis X. The first protruding portion 71A is formed so as to be capable of contacting the sealing member 80 on the first axis X, and is formed so as to be able to restrict movement of the sealing member 80 in the rearward direction X2.

The insertion portion 72 is formed so as to protrude from the end surface of the first base portion 71 in the forward direction X1 in the forward direction X1 toward the forward direction X1. The insertion portion 72 is formed in the overall shape of a rectangular frame. When viewed in the rearward direction X2, the overall planar shape of the insertion portion 72 is a rounded rectangle that is longer along the second axis Y than along the third axis Z. In the present embodiment, the insertion portion 72 has two first long-side portions 72A that extend along the second axis Y and two first short-side portions 72B that extend along the third axis Z. The sealing member 80 is attached to an outer surface of the insertion portion 72. That is, the outer surface of the insertion portion 72 is a sealed surface at an inner circumference of the sealing member 80. The outer surface of the insertion portion 72 does not include a stepped portion along the entire length in the first axis X. That is, no protrusions or recesses are formed on the outer surface of the insertion portion 72. In other words, a protrusion for preventing the sealing member 80 from coming off is not formed at the front end of the insertion portion 72.

As depicted in FIG. 4, the insertion portion 72 is formed so as to be insertable through the opening 42 into the internal space of the shield shell 41. The outer surface of the insertion portion 72 is formed in a shape that corresponds to the inner surface of the shield shell 41.

As depicted in FIG. 3, the cover main body 70 in the present embodiment includes two first engagement portions 73. Each first engagement portion 73 is provided on an inner surface of the insertion portion 72. Each first engagement portion 73 is formed so as to protrude inward from an inner surface of a first short-side portion 72B of the insertion portion 72. As one example, each first engagement portion 73 is provided in the center of the third axis Z on a first short-side portion 72B. The two first engagement portions 73 are provided so as to face each other on the second axis Y.

As depicted in FIG. 4, each first engagement portion 73 extends from the end surface of the insertion portion 72 in the forward direction X1 toward the rearward direction X2. Each first engagement portion 73 includes an inclined surface 73A and an engagement surface 73B. The inclined surface 73A is formed so as to be inclined toward the inside of the insertion portion 72 from the end surface of the insertion portion 72 in the forward direction X1 toward the engagement surface 73B in the forward direction X1. Each engagement surface 73B is an end surface that faces the rearward direction X2. The engagement surfaces 73B face an end surface of the first base portion 71 in the forward direction X1 on the first axis X.

As depicted in FIG. 3, the cover main body 70 in the present embodiment includes four protrusions 74. Each protrusion 74 is formed so as to protrude from the end surface of the insertion portion 72 in the forward direction X1 toward the forward direction X1. Each protrusion 74 is formed in the shape of a rectangular parallelepiped, for example. The protrusions 74 are provided on the first short-side portions 72B of the insertion portion 72. The protrusions 74 are provided near the first engagement portions 73. The four protrusions 74 are provided in pairs near each of the two first engagement portions 73. That is, a pair of protrusions 74 is provided for each first engagement portion 73. Each pair of protrusions 74 is provided so as to sandwich a first engagement portion 73 on the third axis Z. In other words, a pair of protrusions 74 are provided on both sides on the third axis Z of one engagement portion 73.

The first reinforcing ribs 75 are provided in the internal space of the insertion portion 72. The first reinforcing ribs 75 are formed so as to protrude in the forward direction X1 from the end surface of the first base portion 71 in the forward direction X1. The distance by which the first reinforcing ribs 75 protrude from the first base portion 71 is smaller than the distance by which the insertion portion 72 protrudes from the first base portion 71. When viewed in the rearward direction X2, the planar shape of the first reinforcing ribs 75 in the present embodiment has a lattice-like shape or a grid-like shape. In more detail, the first reinforcing ribs 75 in the present embodiment include two first ribs 75A that extend along the second axis Y and two second ribs 75B that extend along the third axis Z. The two first ribs 75A are provided side by side along the third axis Z. Each first rib 75A extends from an inner surface of one first short-side portion 72B of the insertion portion 72 to an inner surface of the other first short-side portion 72B. Each first rib 75A is formed integrally and continuously with the first short-side portions 72B. Each first rib 75A is formed so as to cross two second ribs 75B. The two second ribs 75B are provided side by side along the second axis Y. Each second rib 75B extends from an inner surface of one of the first long-side portions 72A of the insertion portion 72 to the inner surface of the other first long-side portion 72A. Each second rib 75B is formed integrally and continuously with the first long side portions 72A. Each second rib 75B is formed so as to cross two first ribs 75A.

As depicted in FIG. 2, the cover main body 70 in the present embodiment includes two fixing portions 76. Each fixing portion 76 is formed so as to protrude outward from an outer peripheral surface of the first base portion 71. Each fixing portion 76 includes a fixing hole 77 into which a screw B1 is inserted. Each fixing hole 77 is formed so as to pass through the fixing portion 76 along the first axis X. Each fixing hole 77 is provided so as to overlap a screw hole 43 of the shield shell 41 in the forward direction X1. The cover main body 70 is fixed to the shield shell 41 by the screws B1 inserted into the fixing holes 77 and the screw holes 43.

### (Configuration of Sealing Member 80)

As depicted in FIG. 3, the sealing member 80 is attached to the outer periphery of the insertion portion 72. The sealing member 80 is formed to surround the insertion portion 72 around the entire circumference. The sealing member 80 in the present embodiment is formed in a rectangular ring shape. The sealing member 80 is formed in a shape that follows the outer surface of the insertion portion 72. The planar shape of the sealing member 80 when viewed in the forward direction X1 is formed in a rounded rectangular shape with long sides that extend along the second axis Y and short sides that extend along the third axis Z. The sealing member 80 is formed so as to be capable of elastic deformation. As depicted in FIG. 4, when the insertion portion 72 is inserted into the internal space of the shield shell 41, the sealing member 80 comes into close contact with the outer surface of the insertion portion 72 around the entire circumference and also comes into close contact with the inner surface of the shield shell 41 around the entire circumference. In this way, the sealing member 80 forms a seal between the outer surface of the insertion portion 72 and the inner surface of the shield shell 41. The sealing member 80 is made of rubber, for example. Example materials that can be used for the sealing member 80 include silicone rubber, acrylic rubber, and ethylene propylene rubber.

As depicted in FIG. 3, the sealing member 80 includes one or more (in the present embodiment, two) positioning protrusions 81. The two positioning protrusions 81 are provided at intervals around the circumference of the sealing member 80. The two positioning protrusions 81 are provided on long-side portions of the sealing member 80, for example. Each positioning protrusion 81 is formed so as to protrude from an end surface of the sealing member 80 in the forward direction X1 toward the forward direction X1. The two positioning protrusions 81 are provided so as to face each other on the third axis Z.

### (Configuration of Retainer 90)

The retainer 90 is attached in the rearward direction X2 to the cover main body 70, which has the sealing member 80 attached to the outer circumference of the insertion portion 72.

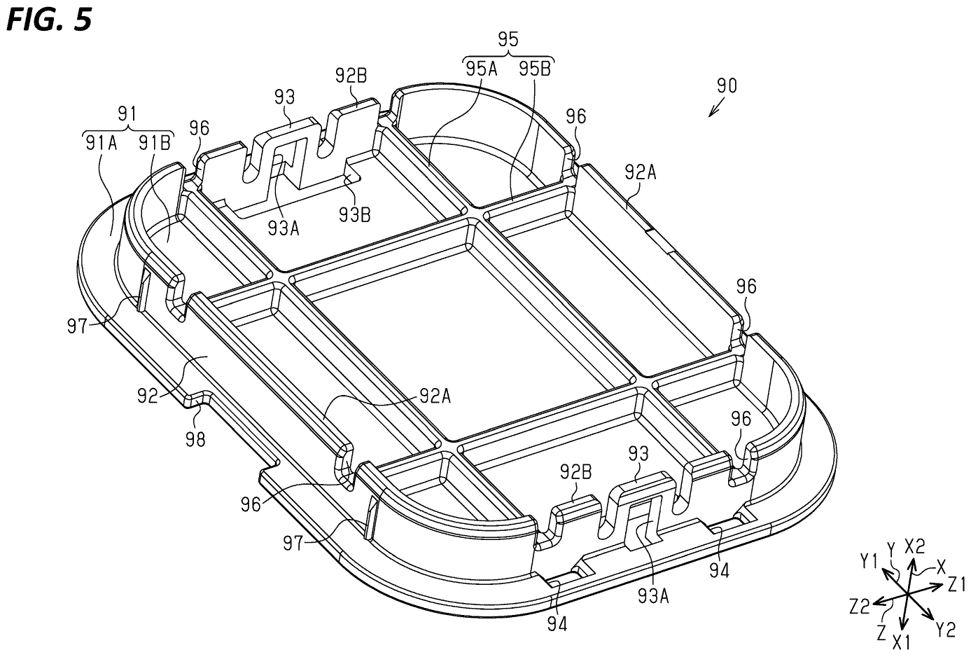

As depicted in FIG. 5, the retainer 90 includes a second base portion 91, a fitting portion 92 formed on an end surface of the second base portion 91 in the rearward direction X2, and second engagement portions 93. The retainer 90 includes holes 94 and second reinforcing ribs 95. The retainer 90 is a single component in which the second base portion 91, the fitting portion 92, the second engagement portions 93, the holes 94, and the second reinforcing ribs 95 are integrally formed. The retainer 90 is made of synthetic resin. As examples, synthetic resin such as polyolefin, polyamide, and ABS resin can be used as the material of the retainer 90.

As depicted in FIG. 3, the second base portion 91 is formed in the shape of a flat plate. The overall planar shape of the second base portion 91 when viewed from the rearward direction X2 is a rounded rectangular shape. The planar shape of the second base portion 91 when viewed from the rearward direction X2 is a rounded rectangular shape with long sides that extend along the second axis Y and short sides that extend along the third axis Z. The second base portion 91 has a thickness along the first axis X.

As depicted in FIG. 5, the second base portion 91 includes a second protruding portion 91A, which protrudes outward from the outer surface of the fitting portion 92, and a cover portion 91B that covers an opening in the forward direction X1 in the fitting portion 92. The second protruding portion 91A is formed continuously around the entire circumference.

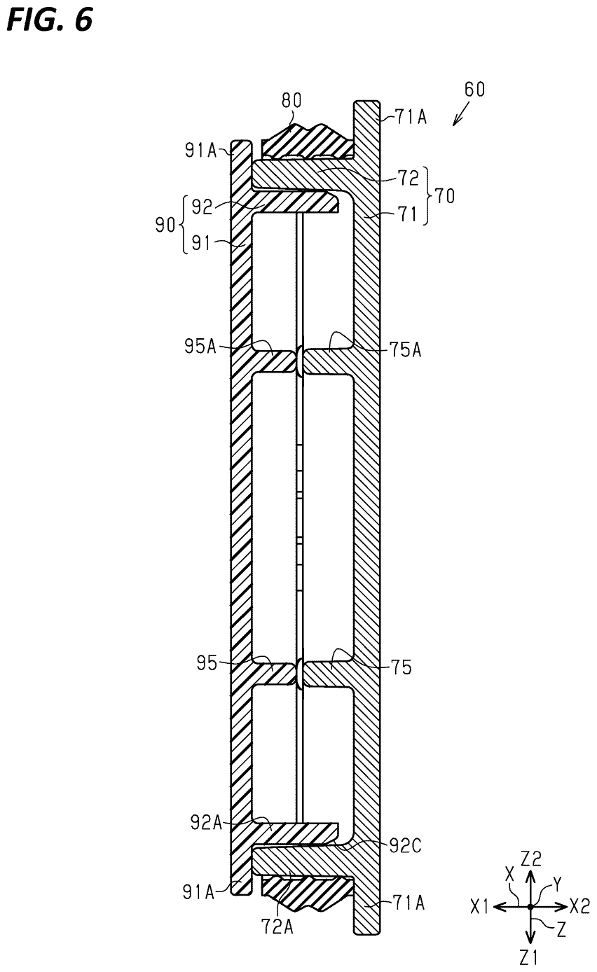

As depicted in FIG. 6, an end surface of the second protruding portion 91A in the rearward direction X2 is formed so as to come into contact with an end surface of the insertion portion 72 in a forward direction X1. The second protruding portion 91A is formed so as to protrude outward from the outer surface of the insertion portion 72. The second protruding portion 91A is formed so as to face the sealing member 80 on the first axis X. The second protruding portion 91A is formed so as to be capable of contacting the sealing member 80 on the first axis X to restrict movement of the sealing member 80 in the forward direction X1. The second protruding portion 91A functions as a retaining portion that prevents the sealing member 80 from coming off the cover main body 70. Here, the sealing member 80 is provided between the first protruding portion 71A and the second protruding portion 91A on the first axis X.

As depicted in FIG. 5, the fitting portion 92 is formed so as to protrude from the end surface of the second base portion 91 in the rearward direction X2 toward the rearward direction X2. The fitting portion 92 is formed in the shape of a frame. The fitting portion 92 in the present embodiment as a whole is formed in a rectangular frame shape. In a plan view in the forward direction X1, the fitting portion 92 is formed in a rounded rectangular shape which as a whole is longer in the second axis Y than in the third axis Z. The fitting portion 92 of the present embodiment has two second long-side portions 92A that extend along the second axis Y and two second short-side portions 92B that extend along the third axis Z. In this way, the shape of the fitting portion 92 in a plan view in the forward direction X1 is formed in the same shape as the shape of the insertion portion 72 (see FIG. 3) in a plan view in the rearward direction X2. In other words, the outer surface of the fitting portion 92 is formed in a shape that follows the inner surface of the insertion portion 72.

As depicted in FIG. 6, the fitting portion 92 is fitted into the insertion portion 72. The distance by which the fitting portion 92 protrudes from the second base portion 91 is smaller than the distance by which the insertion portion 72 protrudes from the first base portion 71. A front-end surface of the fitting portion 92, that is, an-end surface of the fitting portion 92 in a rearward direction X2, does not come into contact the end surface of the first base portion 71 in the forward direction X1. A guide surface 92C is provided at the front end of the fitting portion 92. The guide surface 92C is formed so that the fitting portion 92 becomes thinner toward the front-end surface of the fitting portion 92. The guide surface 92C is provided at a corner between the front-end surface of the fitting portion 92 and the outer surface of the fitting portion 92. The guide surface 92C functions to smoothly guide the fitting portion 92 inside the insertion portion 72 when the fitting portion 92 is inserted into the insertion portion 72.

As depicted in FIG. 5, the retainer 90 in the present embodiment includes two second engagement portions 93. Each second engagement portion 93 is provided on a second short-side portion 92B of the fitting portion 92. In other words, each second engagement portion 93 constructs part of a second short-side portion 92B. As one example, each second engagement portion 93 is provided in the center on the third axis Z of each second short-side portion 92B. The two second engagement portions 93 are provided so as to face each other on the second axis Y. Each second engagement portion 93 is an elastic piece that is capable of elastic deformation and protrudes in the rearward direction X2 from the-end surface of the second base portion 91 in the rearward direction X2. Each second engagement portion 93 is an engagement frame portion, for example. As one example, each second engagement portion 93 is formed as a rectangular frame and has an engagement hole 93A in the center of the frame.

As depicted in FIG. 4, the second engagement portions 93 are formed so as to be capable of engaging the first engagement portions 73. Each second engagement portion 93 is engaged with an engagement surface 73B of a first engagement portion 73 on the first axis X. As one example, the first engagement portions 73 and the second engagement portions 93 engage each other by snap-fitting using elastic deformation of the second engagement portions 93. This engagement between the first engagement portions 73 and the second engagement portions 93 keeps the cover main body 70 and the retainer 90 in an assembled state (combined state).

As depicted in FIG. 5, the retainer 90 includes through holes 93B provided at positions adjacent to the second engagement portions 93. The through holes 93B are provided in positions inward of the fitting portion 92. The through holes 93B are formed so as to pass through the second base portion 91 along the first axis X. The through holes 93B are formed so as to communicate with the engagement holes 93A of the second engagement portions 93. Providing the through holes 93B enables the second engagement portions 93 to elastically deform in a favorable manner.

As depicted in FIG. 3, the retainer 90 in the present embodiment includes four holes 94. The four holes 94 are provided at positions that face the four protrusions 74 on the first axis X. The holes 94 are provided near the second engagement portions 93. The four holes 94 are provided in pairs near each of the two second engagement portions 93. That is, a pair of holes 94 is provided for each second engagement portion 93. Each pair of holes 94 is provided so as to sandwich a second engagement portion 93 on the third axis Z. The holes 94 are provided in the second protruding portion 91A of the second base portion 91.

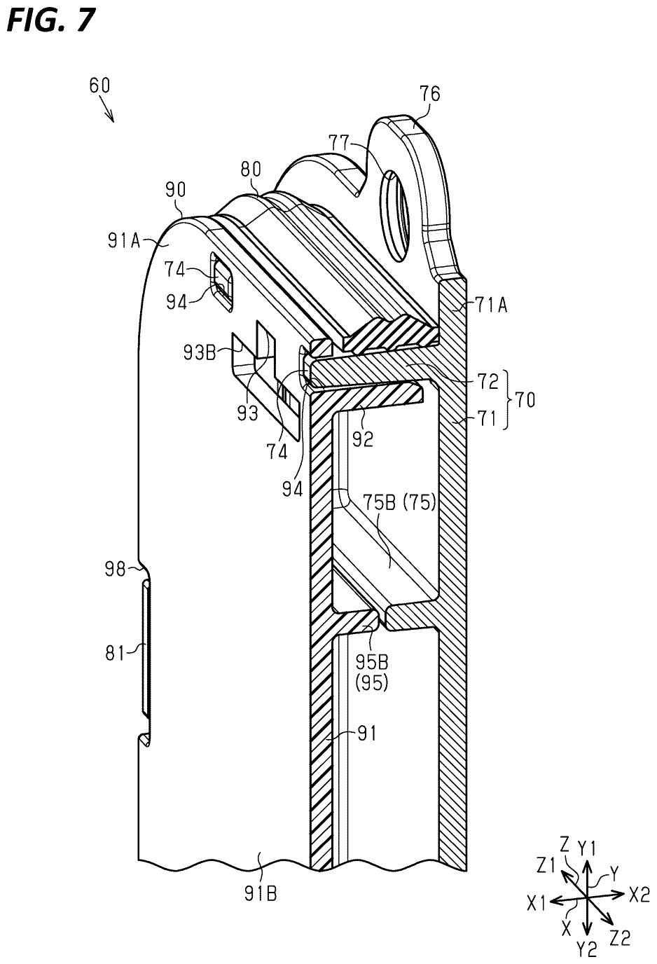

As depicted in FIG. 7, each hole 94 is formed to pass through the second protruding portion 91A along the first axis X. A protrusion 74 is inserted into each hole 94. In this way, a protrusion 74 is inserted into each of the two holes 94 provided near each second engagement portion 93.

As depicted in FIG. 5, the second reinforcing ribs 95 are provided in the internal space of the fitting portion 92. The second reinforcing ribs 95 are formed to protrude in the rearward direction X2 from an end surface of the cover portion 91B in the rearward direction X2. The distance by which each second reinforcing rib 95 protrudes from the second base portion 91 is smaller than the distance by which the fitting portion 92 protrudes from the second base portion 91. When viewed in the forward direction X1, the planar shape of the second reinforcing ribs 95 in the present embodiment is lattice-like or grid-like.

In more detail, the second reinforcing ribs 95 in the present embodiment include two third ribs 95A that extend along the second axis Y and two fourth ribs 95B that extend along the third axis Z. The two third ribs 95A are provided side by side along the third axis Z. Each third rib 95A extends from an inner surface of one second short-side portion 92B of the fitting portion 92 to an inner surface of the other second short-side portion 92B. Each third rib 95A is formed integrally and continuously with the second short-side portions 92B. Each third rib 95A is formed so as to cross two fourth ribs 95B. As depicted in FIG. 6, the third ribs 95A are provided so as to face the first ribs 75A of the cover main body 70 on the first axis X. The distance by which the third ribs 95A protrude is set so that the front-end surfaces of the third ribs 95A (here, the end surfaces in the rearward direction X2) do not come into contact with the front-end surfaces of the first ribs 75A (here, the end surfaces in the forward direction X1) when the retainer 90 has been assembled on the cover main body 70. In other words, a gap is provided between the front-end surfaces of the third ribs 95A and the front-end surfaces of the first ribs 75A.

As depicted in FIG. 5, the two fourth ribs 95B are provided side by side along the second axis Y. Each fourth rib 95B extends from an inner surface of one second long-side portion 92A of the fitting portion 92 to the inner surface of the other second long-side portion 92A. The fourth ribs 95B are formed integrally and continuously with the second long-side portions 92A. Each fourth rib 95B is formed so as to cross two third ribs 95A. As depicted in FIG. 4, as one example, the fourth ribs 95B are provided so as to face the second ribs 75B of the cover main body 70 on the first axis X. The distance by which the fourth ribs 95B protrude is set so that the front-end surfaces of the fourth ribs 95B (here, the end surfaces in the rearward direction X2) do not come into contact with the front-end surfaces of the second ribs 75B (here, the end surfaces in the forward direction X1) when the retainer 90 has been assembled on the cover main body 70. In other words, a gap is provided between the front-end surfaces of the fourth ribs 95B and the front-end surfaces of the second ribs 75B.

As depicted in FIG. 5, the retainer 90 has one or more (in the present embodiment, eight) fitting recesses 96 provided in the fitting portion 92. The eight fitting recesses 96 are provided at intervals in the circumferential direction of the fitting portion 92. Each fitting recess 96 is formed to be recessed in the forward direction X1 from the end surface of the fitting portion 92 in the rearward direction X2. As one example, each fitting recess 96 is formed so as to be recessed in the first axis X up to an end surface of a second reinforcing rib 95 in a rearward direction X2.

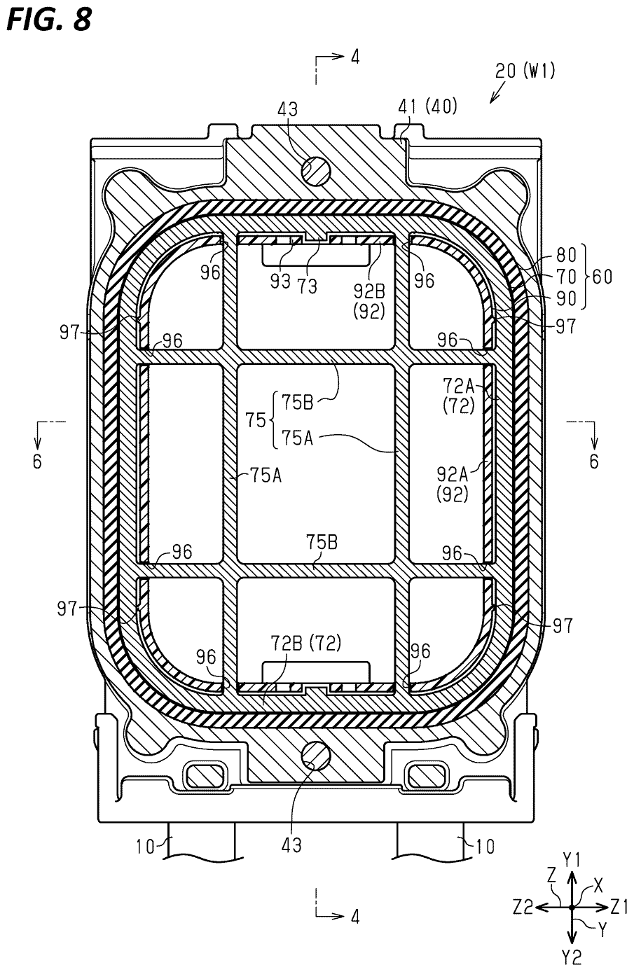

As depicted in FIG. 8, the first reinforcing ribs 75 fit into the fitting recesses 96. Out of the eight fitting recesses 96, the first ribs 75A fit into the four fitting recesses 96 provided on the second short sides 92B. The inner surfaces of the four fitting recesses 96 provided on the second short-side portions 92B are capable of coming into contact with the first ribs 75A in the first width direction Z1 and are also capable of coming into contact with the first ribs 75A in the second width direction Z2. Out of the eight fitting recesses 96, the second ribs 75B fit into the four fitting recesses 96 provided on the second long-side portions 92A. The inner surfaces of the four fitting recesses 96 provided on the second long-side portions 92A are capable of coming into contact with the second ribs 75B in the upward direction Y1 and are also capable of coming into contact with the second ribs 75B in the downward direction Y2.

The retainer 90 also includes one or more (in the present embodiment, four) crushing ribs 97. Each crushing rib 97 is provided on the outer surface of the fitting portion 92. Each crushing rib 97 extends along the direction in which the fitting portion 92 fits into the insertion portion 72 (here, the rearward direction X2). As depicted in FIG. 5, each crushing rib 97 extends from an end surface of the second base portion 91 in the rearward direction X2 to an intermediate position in the height direction of the fitting portion 92 in the rearward direction X2.

As depicted in FIG. 8, the four crushing ribs 97 are provided at intervals around the circumference of the fitting portion 92. The four crushing ribs 97 are provided on the outer surfaces of the second long-side portions 92A of the fitting portion 92. By providing these crushing ribs 97, when the fitting portion 92 is inserted into the insertion portion 72, the crushing ribs 97 become inserted while being squeezed, so that the fitting portion 92 becomes inserted into the insertion portion 72 in substantially a press-fitted state. When the fitting portion 92 has been inserted into the insertion portion 72, the crushing ribs 97 are crushed by the inner surface of the insertion portion 72 so that the crushing ribs 97 become squeezed against the inner surface of the insertion portion 72. By doing so, it is possible to suppress rattling between the insertion portion 72 and the fitting portion 92, and in turn to suppress rattling between the cover main body 70 and the retainer 90.

As depicted in FIG. 3, the retainer 90 has one or more (in the present embodiment, two) positioning recesses 98. Each positioning recess 98 is provided so as to face a positioning protrusion 81 of the sealing member 80 on the first axis X. The two positioning protrusions 81 are fitted into the two positioning recesses 98. Here, the sealing member 80 is positioned relative to the retainer 90 in the circumferential direction by fitting the two positioning protrusions 81 into the two positioning recesses 98.

The positioning recesses 98 are provided in the second protruding portion 91A. Each positioning recess 98 is formed so as to be recessed inward from the outer circumferential surface of the second protruding portion 91A. Each positioning recess 98 is formed so as to be cut out in the outer circumferential surface of the second protruding portion 91A. The inner surface of each positioning recess 98 can come into contact with a positioning protrusion 81 in the upward direction Y1 and can also come into contact with the positioning protrusion 81 in the downward direction Y2. By doing so, it is possible to suppress movement of the sealing member 80 relative to the retainer 90 in the upward direction Y1 and in the downward direction Y2. This makes it possible to suppress rotation of the sealing member 80 relative to the retainer 90.

As depicted in FIG. 2, the cover member 60 described above is assembled onto the shield shell 41 in the forward direction X1 in a state where the sealing member 80 and the retainer 90 have been attached to the cover main body 70. The cover member 60 is fixed to the shield shell 41 by the screws B1.

### (Operation and Effects of the Present Embodiment)

Next, the operation and effects of the present embodiment will be described.

(1) The connector 20 includes the terminals 30, which are electrically conductive, and a metallic shield shell 41 that covers the terminals 30. The connector 20 includes the cover member 60 that is attached to the shield shell 41 along the first direction (here, the forward direction X1) so as to cover the opening 42 provided in the shield shell 41. The cover member 60 includes the metallic cover main body 70 with the first base portion 71 that covers the opening 42, the frame-shaped insertion portion 72 that protrudes from the first base portion 71 in the forward direction X1 and is inserted into the shield shell 41, and the first engagement portions 73. The cover member 60 is attached to the outer circumference of the insertion portion 72 and includes the annular sealing member 80 that forms a seal between the insertion portion 72 and the shield shell 41. The cover member 60 is attached to the cover main body 70 and includes the retainer 90 that is made of synthetic resin and prevents the sealing member 80 from coming off the insertion portion 72. The retainer 90 includes the second engagement portion 93 that is formed so as to engage the first engagement portion 73.

With this configuration, the cover member 60 attached to the shield shell 41 includes the cover main body 70, which is made of metal and includes the insertion portion 72 that is inserted into the shield shell 41, and the sealing member 80, which is attached to the outer circumference of the insertion portion 72. The cover member 60 also includes the retainer 90 that is made of synthetic resin and prevents the sealing member 80 from coming off. This means that the retainer 90, which is a separate part from the cover main body 70, can prevent the sealing member 80 from coming off the insertion portion 72. Accordingly, there is no need to provide a structure, such as a convex portion, for preventing the sealing member 80 from coming off the front end of the insertion portion 72 of the cover main body 70. This means that the cover main body 70 can be manufactured without using a slide mold. By doing so, it is possible to favorably suppress the formation of burrs on the outer surface of the insertion portion 72, that is, the sealed surface, which makes it unnecessary to perform a cutting process to remove burrs. Accordingly, it is possible to prevent minute height differences, which are produced by a cutting process, from being formed on the sealed surface. As a result, compared to a case where a convex portion is provided at the front end of the insertion portion 72, the sealing performance of the sealing member 80 can be improved, which in turn improves the waterproof properties of the connector 20.

(2) The second engagement portions 93 that engage the first engagement portions 73 are formed to be capable of elastic deformation in the second direction (here, the upward direction Y1 or the downward direction Y2) that is perpendicular to the first direction. Here, since the retainer 90 is made of synthetic resin, unlike the cover main body 70 which is made of metal, the cover main body 70 and the retainer 90 have different thermal expansion coefficients. Due to this difference in thermal expansion coefficients, there can be cases where the retainer 90 thermally shrinks more than the cover main body 70. When this happens, if the retainer 90 undergoes large thermal shrinkage in the second direction, there is a risk of the engagement between the first engagement portions 73 and the second engagement portions 93 being unintentionally released.

To cope with this, in the connector 20, a pair of protrusions 74 are provided on the cover main body 70 so as to sandwich the first engagement portions 73, and the pair of holes 94 into which the pair of protrusions 74 fit are provided on the retainer 90. In more detail, the inner surface of each hole 94 is provided so as to be capable of coming into contact with a metal protrusion 74 in the second direction. Such contact between the holes 94 and the protrusions 74 can prevent the retainer 90 from thermally shrinking in the second direction in the vicinity of the first engagement portions 73 and the second engagement portions 93. This makes it possible to prevent the second engagement portions 93 from thermally shrinking significantly in the second direction. By doing so, it is possible to preferably prevent the engagement between the first engagement portions 73 and the second engagement portions 93 from being unintentionally released due to thermal shrinkage of the retainer 90.

(3) The fitting portion 92, whose outer surface follows the inner surface of the insertion portion 72, is fitted into the insertion portion 72. This means that the retainer 90 can be attached to the cover main body 70 while fitting the fitting portion 92 inside the insertion portion 72. Accordingly, the retainer 90 can be attached to the cover main body 70 while being aligned by fitting the fitting portion 92 into the insertion portion 72. As a result, the task of attaching the retainer 90 to the cover main body 70 can be facilitated.

(4) The retainer 90 is attached to the cover main body 70 by the engagement between the first engagement portions 73 and the second engagement portions 93 using elastic deformation of the second engagement portions 93. This means that some rattling can occur between the cover main body 70 and the retainer 90. If the structure rattles, there is the problem of noise being produced when the structure is subjected to vibration.

To counteract this, the connector 20 is provided with the crushing ribs 97 on the outer surface of the fitting portion 92. The crushing ribs 97 are press-fitted into the insertion portion 72. With this configuration, when the fitting portion 92 is fitted into the insertion portion 72, the crushing ribs 97 are crushed by the inner surface of the insertion portion 72 so that the crushing ribs 97 are squeezed against the inner surface of the insertion portion 72. This makes it possible to suppress rattling between the insertion portion 72 and the fitting portion 92, and in turn to suppress rattling between the cover main body 70 and the retainer 90.

(5) The sealing member 80 is provided between the first protruding portion 71A on the first base portion 71 of the cover main body 70 and the second protruding portion 91A of the second base portion 91 of the retainer 90. By doing so, the movement of the sealing member 80 in the first direction (here, the forward direction X1) and a first opposite direction (here, the rearward direction X2) can be restricted by the second protruding portion 91A and the first protruding portion 71A. It is therefore possible to favorably prevent the sealing member 80 from coming off the insertion portion 72.

(6) On the cover main body 70, the first reinforcing ribs 75 are formed so as to protrude in the forward direction X1 from the end surface of the first base portion 71 in the forward direction X1. By providing these first reinforcing ribs 75, the rigidity of the cover main body 70 can be increased. The retainer 90 also includes the second reinforcing ribs 95 that are formed so as to protrude in the rearward direction X2 from the end surface of the cover portion 91B in the rearward direction X2. By providing these second reinforcing ribs 95, the rigidity of the retainer 90 can be increased.

(7) A gap is provided between the end surface of the first reinforcing ribs 75 forward direction X1 and the-end surface of the second reinforcing ribs 95 in the rearward direction X2. With this configuration, the first reinforcing ribs 75 and the second reinforcing ribs 95 do not come into contact with each other when the retainer 90 is attached to the cover main body 70. This means that it is possible to suppress the generation of noise due to contact between the first reinforcing ribs 75 and the second reinforcing ribs 95.

(8) The first reinforcing ribs 75 fit into the fitting recesses 96 provided on the end surface of the fitting portion 92 in the rearward direction X2. When this happens, since the inner surfaces of the fitting recesses 96 are capable of coming into contact with the first reinforcing ribs 75 in a direction that intersects the forward direction X1, it is possible to suppress movement of the retainer 90 in a direction that intersects the forward direction X1. By doing so, it is possible to favorably suppress tilting of the retainer 90 relative to the cover main body 70.

(9) The positioning protrusions 81 of the sealing member 80 fit into the positioning recesses 98 provided on the retainer 90. When doing so, since the positioning protrusions 81 are capable of coming into contact with the inner surfaces of the positioning recesses 98 in the second direction (here, the upward direction Y1 or the downward direction Y2), movement of the sealing member 80 in the second direction can be suppressed. By doing so, rotation of the sealing member 80 relative to the retainer 90 is suppressed.

### (Modifications)

The embodiment described above can be modified as follows. The embodiment described above and the modifications given below can be combined within a range that remains technically consistent.
The structure of the cover main body 70 in the above embodiment may be modified as appropriate.
The structure of the first reinforcing ribs 75 may be modified as appropriate. The number of the first ribs 75A may be changed. The number of second ribs 75B may also be changed. Either the first ribs 75A or the second ribs 75B may be omitted.
The first reinforcing ribs 75 may be omitted. That is, both the first ribs 75A and the second ribs 75B may be omitted.
The positions where the first engagement portions 73 are formed may be changed. As one example, the first engagement portions 73 may be provided on the inner surfaces of the first long-side portions 72A. In this case, the second engagement portions 93 of the retainer 90 are provided on the second long-side portions 92A. In this case also, it is preferable for two protrusions 74 to be provided so as to sandwich each first engagement portion 73 on the second axis Y.
The number of protrusions 74 may be changed.
The structure of the sealing member 80 in the above embodiment may be modified as appropriate. As one example, the positioning protrusions 81 may be omitted.
The structure of the retainer 90 in the above embodiment may be modified as appropriate.
The positioning recesses 98 may be omitted.
The number of crushing ribs 97 may be changed. The crushing ribs 97 may be provided on the outer surface of the second short-side portions 92B.
The crushing ribs 97 may be omitted.
The fitting recesses 96 may be omitted.
The structure of the second reinforcing rib 95 may be changed as appropriate. The number of the third ribs 95A may be changed. The number of the fourth ribs 95B may be changed. Either the third ribs 95A or the fourth ribs 95B may be omitted.
The second reinforcing ribs 95 may be omitted. That is, both the third ribs 95A and the fourth ribs 95B may be omitted.
Although the holes 94 are formed so as to pass through the second base portion 91 along the first axis X in the embodiment described above, the present disclosure is not limited to this. As one example, the holes 94 may be formed so as to not pass through the second base portion 91 along the first axis X. That is, the holes 94 may be formed in concave shapes that are recessed in the forward direction X1 from the end surface of the second base portion 91 in the rearward direction X2.
The fitting portion 92 may be omitted.
The cover portion 91B of the second base portion 91 may be omitted.
The structure of the connector housing 40 in the above embodiment may be modified as appropriate. As one example, the inner housing 50 and the lid portion 55 may be integrally formed.
The shield bracket 100 may be omitted.
The number of terminals 30 provided in the connector 20 according to the embodiment described above is not limited to two. As examples, the number of terminals 30 provided in the connector 20 may be one, or three or more. Note that the number of electric wires 10 may be modified as appropriate in keeping with the number of terminals 30.
The embodiments disclosed above are exemplary in all respects and should not be regarded as limitations on the present disclosure. The scope of the present disclosure is indicated by the range of the patent claims, not the description given above, and is intended to include all changes within the meaning and scope of the patent claims and their equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a terminal that is electrically conductive;
a shield shell that is made of metal and covers the terminal; and
a cover member that is attached to the shield shell along a first direction so as to cover an opening provided in the shield shell,
wherein the cover member includes:
a cover main body that is made of metal and includes a first base portion that covers the opening, an insertion portion that is frame-shaped, protrudes from the first base portion in a first direction and is inserted into the shield shell, and a first engagement portion;
an annular sealing member that is attached to an outer circumference of the insertion portion and forms a seal between the insertion portion and the shield shell; and
a retainer that is made of synthetic resin, is attached to the cover main body, and prevents the sealing member from coming off the insertion portion, and
wherein the retainer includes a second engagement portion formed to be capable of engaging the first engagement portion.

2. The connector according to claim 1,
wherein the second engagement portion is an elastic piece capable of elastic deformation in a second direction that is perpendicular to the first direction,
the cover main body includes a pair of protrusions provided so as to sandwich the first engagement portion in a third direction that is perpendicular to both the first direction and the second direction,
the retainer includes a pair of holes provided so as to sandwich the second engagement portion in the third direction,
each protrusion in the pair of protrusions protrudes in the first direction from a first direction-end surface of the insertion portion,
the pair of protrusions are fitted into the pair of holes, and
inner surfaces of the pair of holes are capable of contacting the protrusions in the second direction.

3. The connector according to claim 1,
wherein the retainer includes a second base portion and a fitting portion that protrudes in a first opposite direction, which is an opposite direction to the first direction, from the second base portion, and
the fitting portion has an outer surface that conforms to an inner surface of the insertion portion and is fitted into the insertion portion.

4. The connector according to claim 3,
wherein the retainer includes one or a plurality of crushing ribs provided on an outer surface of the fitting portion,
each crushing rib extends along the first direction, and
each crushing rib is press-fitted into the insertion portion.

5. The connector according to claim 3,
wherein the first base portion includes a first protruding portion that protrudes outward beyond the insertion portion,
the second base portion includes a second protruding portion that protrudes outward beyond the fitting portion and faces the first protruding portion in the first direction, and
the sealing member is provided between the first protruding portion and the second protruding portion in the first direction.

6. The connector according to claim 3,
wherein the cover main body includes a first reinforcing rib formed to protrude in the first direction from a first direction-end surface of the first base portion,
the second base portion includes a cover portion that covers an opening in the first direction of the fitting portion, and
the retainer includes a second reinforcing rib formed to protrude in the first opposite direction from a first opposite direction-end surface of the cover portion.

7. The connector according to claim 6,
wherein a gap is provided between a first direction-end surface of the first reinforcing rib and a first opposite direction-end surface of the second reinforcing rib.

8. The connector according to claim 6,
wherein the retainer includes a fitting recess with which the first reinforcing rib is fitted,
the fitting recess is formed to be recessed in the first direction from a first opposite direction-end surface of the fitting portion, and
an inner surface of the fitting recess is capable of coming into contact with the first reinforcing rib in a direction that intersects the first direction.

9. The connector according to claim 3,
wherein the sealing member includes a positioning protrusion that protrudes in the first direction from a first direction-end surface of the sealing member,
the retainer includes a positioning recess into which the positioning protrusion is fitted,
the positioning recess is formed by cutting out an outer peripheral surface of the second base portion, and
the inner surface of the positioning recess is capable of coming into contact with the positioning protrusion in a second direction that is perpendicular to the first direction.
